(19) United States
(12) Patent Application Publication
(10) Pub. No.: US 2006/0118496 A1
(43) Pub. Date: Jun. 8, 2006

(54) Water treatment using metal porphyrin

(75) Inventors: H. Eric Nuttall, Albuquerque, NM (US); John A. Shelnutt, Tijeras, NM (US); William L. Anderson, Albuquerque, NM (US); Jim E. Studer, Albuquerque, NM (US)

Correspondence Address: Mr. Edward J. Timmer, P.O. Box 770, Richland, MI, 49083-0770, US

(73) Assignee: University of New Mexico

(21) Appl. No.: 11/248,606

(22) Filed: Oct. 12, 2005

Related U.S. Application Data
(60) Provisional application No. 60/617,945, filed on Oct. 12, 2004.

(51) Int. Cl. C02F 1/70

(52) U.S. Cl. 210/748; 210/757

(57) ABSTRACT

Water treatment method involves contacting water containing a dissolved contaminant or unwanted reducible species or a recoverable species and metal porphyrin as a reductive catalyst in the presence of an electron donor in a reactor under conditions to reduce the reducible species. The reduction of the contaminant or unwanted or recoverable species can be catalyzed by light or electrical activation of the metal porphyrin.

This application claims benefits and priority of provisional application Ser. No. 60/617,945 filed Oct. 12, 2004.

### CONTRACTUAL ORIGIN OF THE INVENTION

This invention was supported in part by funding from the Federal Government through the Consortium for Environmental Education and Technology Development in cooperation with the Department of Energy. The Government may have certain rights in the invention.

### FIELD OF THE INVENTION

The present invention relates to a method of treating groundwater, surface water, waste water or other water including a contaminant or unwanted reducible species and/or a recoverable reducible species using a metal porphyrin as a reductive catalyst.

### BACKGROUND OF THE INVENTION

Certain bacteria contain enzymes which effect anaerobic reduction/transformation of toxic metal anions and organics in ground water. One such bacteria comprises cytochrome c₃ from D. baculatum. However, the use of bacteria to remediate groundwater suffers from certain disadvantages resulting from use of a living organism. In particular, a ground water remediation process using living bacteria is not readily controllable in a chemical processing sense. That is, the beginning and the end as well as the rate of remediation using living bacteria are not readily controllable.

An object of the present invention is to provide a controllable chemical water treatment method for treating ground water, surface water, waste water, and other water containing a reducible species.

### SUMMARY OF THE INVENTION

The present invention provides a method for treating water that contains a contaminant or unwanted reducible species and/or a recoverable reducible species wherein the method involves contacting the water to be treated and a metal porphyrin on a substrate in a reactor under conditions to achieve reduction of the reducible species. Reduction of the reducible species facilitates its removal from the water or transforms it to a more environmentally friendly or innocuous form (nonhazardous species).

In an illustrative embodiment of the present invention, the metal porphyrin preferably comprises tin porphyrin or antimony porphyrin disposed as a monolayer or other layer or deposit on the substrate.

In another illustrative embodiment of the present invention, an electron donor is present when the water to be treated and the metal porphyrin are contacted in the reactor. The electron donor preferably comprises an electron donor material such as ethanol, which is added to the water to be treated before and/or after the water to be treated enters the reactor. The electron donor alternately may comprise a DC electrical current or voltage applied to a substrate on which the metal porphyrin resides in the reactor.

In another illustrative embodiment of the present invention, the reduction of the reducible species can be catalyzed by light activation or by electrical activation using DC voltage or current to increase the rate of reduction.

In a further illustrative embodiment of the present invention, the reducible species comprises dissolved metal cations including, but not limited to, Au, Ag, Pt, Cu, Cr, Pb, Hg or U cations, dissolved in the water. The metal cations can be reduced to elemental metal (zero valence) or a lower valence state in the reactor. In addition, metal-oxygen cation species can be reduced to a more environmentally innocuous mineral form thereof.

In a still further illustrative embodiment of the present invention, the reducible species comprise dissolved anions including, but not limited to, perchlorate, chlorate, chlorite, or nitrate anions, dissolved in the water.

In an additional illustrative embodiment of the present invention, the reducible species can comprise a halogenated hydrocarbon solvent, an organic dye, the fuel additive MTBE, a herbicide, or an insecticide.

Other features of the present invention will be set forth in the following detailed description taken with the following drawings.

### DESCRIPTION OF THE DRAWINGS

FIG. 1 is a schematic view of a reactor column and associated components for use in practicing an embodiment of the present invention.

FIG. 2 illustrates the molecular structure of a tin porphyrin for use in practicing an embodiment of the present invention.

### DESCRIPTION OF THE INVENTION

The present invention provides a chemical water treatment method for treating ground water, surface water, waste water from a manufacturing process, and any other water or aqueous solution containing contaminant or unwanted reducible species and/or a recoverable resource species wherein metal porphyrin is employed as a reductive catalyst in the presence of an electron donor under conditions in a reactor to achieve reduction of the contaminant or unwanted reducible species and/or the recoverable resource species.

As used herein, metal porphyrin is intended to mean a molecule having a metal atom bound to the porphyrin system wherein the molecule can be modified by the attachment and/or addition of various organic groups to the porphyrin system. Preferred metal porphyrins for use in practice of the present invention include, but are not limited to, tin porphyrin and antimony porphyrin.

In illustrative embodiment of the invention, the metal porphyrin is provided as a monolayer on a substrate in a reactor and is activated or catalyzed as described below to promote reduction of the reducible species in the water. The monolayer can be deposited on the substrate by a chemical attachment process, such as including but not limited to using amino-modified glass substrates, poly-lysine modified glass substrates, and other substrates. The glass substrates can be solid or porous glass beads for purposes of illustration and not limitation. The invention is not limited to use of a monolayer of the metal porphyrin and can be practiced with thicker and/or multiple layers of metal porphyrin or using a metal porphyrin gel such as metal porphyrin based on or attached to amino agarose gel.

The electron donor can comprise an electron donor material such as an alcohol in the water. A preferred electron donor material for use in practice of the invention includes, but is not limited to, ethanol added to the water. Alternately or in addition, the invention can be practiced using an electron donor that involves the application of direct electrical voltage or current to the metal porphyrin.

The reduction of the reducible species can be promoted by photocatalysis. To this end, a light source is provided to impinge light, either ultravoilet (UV) or visible light, or both, on the metal porphyrin to achieve light activation of the metal porphyrin. Any suitable light source can be used in practice of the invention. Alternately, the reduction of the reducible species can be catalyzed by electrical activation of the metal porphyrin. For example, a monolayer of metal porphyrin can be provided on an electrically conductive substrate in the reactor. A DC voltage or current can be applied to the substrate to achieve electrical activation of the metal porphyrin. Electrical activation can serve the dual role of activation of the metal porphyrin and also of electron donation as described in the preceding paragraph. When electrical activation of the metal porphyrin is employed, the electron donor material such as ethanol and the light source can be omitted, allowing treatment of groundwater in-situ in the ground (e.g. in a bore hole).

The water treatment reactor can comprise a reactor column having substrates therein, such as glass or other beads, coated with a monolayer or other layer of metal porphyrin, or any other type of reactor vessel having suitable substrate(s) of any shape, such as plates, coated with metal porphyrin. The water to be treated can be introduced into the reactor in batch manner or in continuous manner. When the metal porphyrin is light activated, the electron donor material can be added to the water to be treated before and/or after the water to be treated enters the reactor.

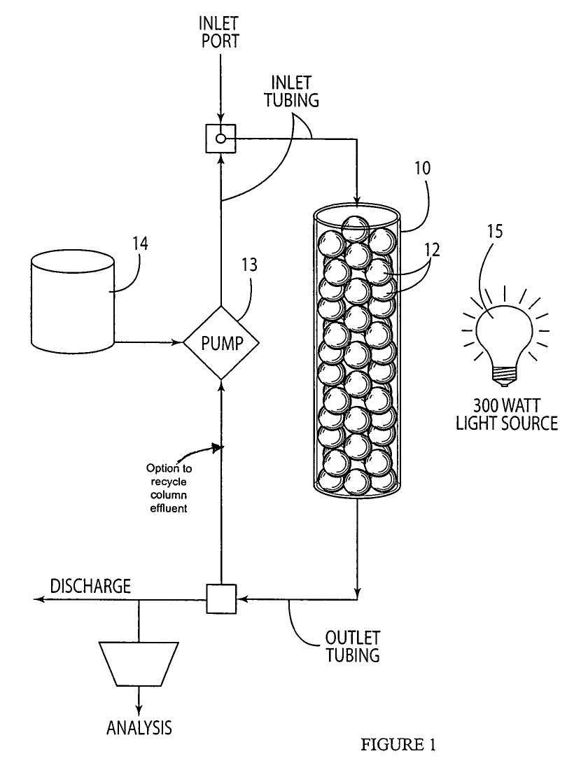

For purposes of illustration and not limitation, FIG. 1 shows a reactor column 10 for practicing an embodiment of the water treatment method of the present invention. The reactor column can comprise a light transmitting glass column 10 that receives water to be treated via inlet tubing shown. The glass column 10 resides in an aluminum foil lined box (not shown) having a window to admit light from a light source 15 and reflect the light about the glass column. Any means can be used to surround the glass column with light. For example, one or more light sources and/or light reflectors/mirrors can be used to provide light surrounding and impinging the glass column 10. One or more internal lighting sources or elements also can be located at the center or other location internally of the reactor column 10.

The glass column 10 is packed internally with metal prophyrin catalyst coated, light transmitting glass beads (substrates) 12. The glass beads are coated with a monolayer of the metal porphyrin catalyst by a chemical attachment process described in the Example below. The glass beads (substrates) are light transmitting to enhance light activation of the process.

The water to be treated can be pumped by pump 13 from a water source such as a water tank 14, where an electron donor material, such as ethanol, is introduced into the water to be treated. The water to be treated is pumped from the water tank 14 by pump 13 to the top of the column 10 for flow downward over the metal porphyrin coated glass beads 12. Alternately, as described in the Example below, the water to be treated can be introduced into the inlet tubing at an inlet port shown in FIG. 1. A UV or visible light source 15 is provided outside the foil-lined box to direct light through the box window in a manner to illuminate and light activate the metal porphyrin reductive catalyst and thereby photocatalzye the reduction of the reducible species. For example, metal cation species, such as M⁺, are reduced to elemental metal deposit, M⁰, and deposited on the metal porphyrin in the reactor. The treated water (column effluent) optionally can be recycled back to the pump 13 for flow through the column 10 if desired. The column effluent also optionally can be sampled by a fraction collector 16 for analysis.

The following reductions of metal cations to elemental metal or a lower valence state in the presence of light activated (light input) tin porphyrin catalyst are offered to illustrate, but not limit, embodiments of the invention:
HAuCl₄.xH₂O [symbol] Au⁰+4Cl⁻+H⁺+xH₂O
Ag(NO₃)₂ [symbol] Ag⁰+2NO₃⁻
H₂PtCl₆.6H₂O [symbol] Pt⁰+6Cl⁻+2H⁺+6H₂O
CuCl₂.2H₂O [symbol] Cu⁰+2Cl⁻+2H₂O
Pb(NO₃)₂ [symbol] Pb⁰+2NO₃⁻
HgCl₂ [symbol] Hg⁰+2Cl⁻
Cr⁺⁶ [symbol] Cr⁺³ (forms insoluble species)
The elemental metal is deposited on the metal porphyrin and is thereby removed from the treated water. The Cr⁺³ forms an insoluble species such as Cr₂O₃.

The following reduction of a metal-oxygen cation species to a more environmentally friendly mineral oxide in the presence of light activated tin porphyrin catalyst is offered to illustrate, but not limit, another embodiment of the invention:
UO₂(NO₃)₂.6H₂O [symbol] UO₂+2NO₃⁻+6H₂O
The mineral oxide can be readily removed from the treated water by subsequent filtration of the treated water.

Recovery of one or more valuable metallic or mineral resources such as platinum, gold, and silver in an aqueous solution can be achieved through the above embodiments.

If the reducible species comprise perchlorate anions, the anions are reduced in one or more reductive steps to more environmentally friendly chloride in the reactor. The following reduction of chlorine-bearing anions to chloride in the presence of light activated tin porphyrin catalyst is offered to illustrate, but not limit, still other embodiments of the invention: 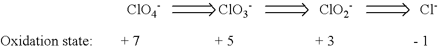
The chloride ions can remain in the water as a harmless species.

If the reducible species comprise nitrate anions, the anions are reduced in one or more reductive steps to harmless nitrogen gas in the reactor (i.e. denitrification). The following reduction of nitrate anion in the presence of light activated tin porphyrin catalyst is offered to illustrate, but not limit, still other embodiments of the invention:
NO₃⁻ [symbol] NO₂ [symbol] N₂

The nitrogen gas can be readily removed from the treated water.

Other embodiments of the present invention envision catalyzed reduction of chlorinated hydrocarbon solvents. For purposes of illustration, an illustrative embodiment of the invention envisions reducing trichloroethylene (TCE) to ethene in the presence of light activated tin porphyrin catalyst.

Still other embodiments of the present invention envision catalyzed reduction of organic dyes. For purposes of illustration, an illustrative embodiment of the invention envisions reducing nitroblue tetrazolium (NBT) to NBT-Formazan in the presence of light activated tin porphyrin catalyst.

The following Example is offered to further illustrate the invention without limiting the scope of the invention.

### EXAMPLE

A 0.25 ml batch sample of 0.0005 M potassium dichromate aqueous solution was subjected to a treatment in a reactor column using a particular tin porphyrin as a photoactivated reductive catalyst to reduce the Cr⁺⁶ to Cr⁺³.

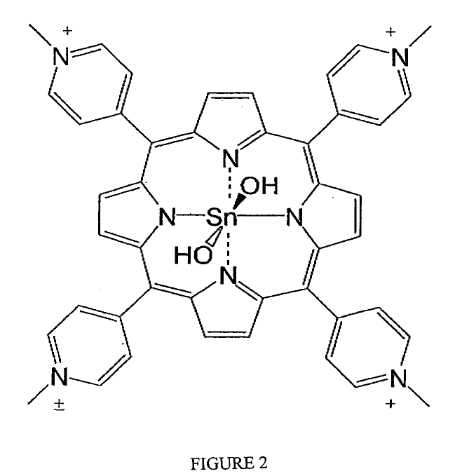

The potassium dichromate solution (batch sample) was injected at an inlet port into the inlet tubing to the top of a glass column having an inner diameter of 0.9 cm and a length of 20 cm packed with 212 tin porphyrin-coated, solid glass beads each having a diameter of 300 microns. The tin porphyrin comprised Sn-IV meso Tetra IV carboxyphenyl porphine available from Frontier Scientific Inc., Logan, Utah. The structure of this particular tin porphyrin is shown in FIG. 2.

The glass column was enclosed in an aluminum foil lined box having a window. A 300 watt halogen light (Kodak Carousel 760H, 300 Watts) was positioned 7-8 inches from the window to illuminate the glass column and its contents.

The batch sample was injected into a buffer solution flowing (pumped) through the glass column at a flow rate controlled by a peristaltic pump. The buffer solution comprised 0.01 M sodium phosphate solution having a pH of 7.1 and contained 10 weight % ethanol as an electron donor material. The buffer solution was prepared by dissolving 6.25 grams of NaH₂PO₄.6H₂O and 22.48 grams of NaHPO₄ in a total of 1 liter of distilled water.

The glass beads were coated with the above tin porphyrin by the following procedure. The glass beads were soaked for 10 minutes in 1M NaOH and dried under vacuum. The glass beads then were sequentially washed with distilled water, ethanol, distilled water, 1N HCl, distilled water 1M NaOH, and distilled water and then dried under vacuum. The glass beads then were oven dried at 100 degrees C. overnight (15-20 hours). The glass beads then were placed in a conical flask and soaked in acetone by manually swirling the glass beads for 10 minutes. Then, 5 mL of aminopropyl triethoxy silane (triethoxyaminopropylsilane) available from Sigma-Aldrich located at St. Louis, Mo. was added to the acetone in the flask at room temperature followed by continued swirling of the glass beads for another 10 minutes. The glass beads remained soaking in the flask for 4-5 hours with shaking of the the flask regularly for 2-3 minutes every hour. The glass beads were removed from the flask and dried in an oven at 100 degrees C. overnight. After drying, the glass beads were placed in a funnel to which then was added about 160-200 ml of DMF (dimethyl formamide). A solution of 20 mg of the tin porphyrin in 100 ml of DMF was prepared and added to the funnel containing the glass beads and the DMF. Then, about 1 gram of DCC (1,3 dicyclohexylcarbodiimide available from Aldrich Chemical Co.) was added to the funnel, which was shaken well to mix all of the constituents. The funnel was covered with aluminum foil and left to sit overnight. On the next day, the purple colored liquid was removed from the funnel and the porphyrin coated glass beads were washed with DMF. The purple liquid was the unattached porphyrin in DMF. The coated glass beads were thoroughly washed with acetone for 30 minutes until the liquid coming out was no longer purple. The porphyrin coated glass beads were then soaked overnight in acetone covered with an aluminum foil.

In preparation for loading into the glass column, the coated glass beads were washed with 1 liter of the phosphate buffer solution for 20-25 minutes and dried under vacuum. The lower end of the glass column is sealed with silicone glue, and the buffer solution was introduced into the column to fill it with the buffer solution. The porphyrin coated glass beads were loaded into the column filled with the buffer solution using a spatula such that the glass beads settled and packed in the column. The buffer solution was removed with a suction dropper as the glass beads filled the interior volume of the column. The glass beads were loaded until the interior volume of the glass column was filled to the top end. A stopper then was inserted in the top end of the glass column while ensuring that no air bubbles entered the column. The top of the glass column was sealed with silicone glue. Inlet tubing was connected to the top end of the glass column. The inlet tubing was connected to peristaltic pump that, in turn, was connected to a source of a buffer solution for pumping the buffer solution through the glass column. Outlet tubing was connected to the lower end of the glass column to discharge treated solution from the glass column.

The above referenced buffer solution (90% sodium phosphate solution at 0.01M and 10% ethanol) was purged with nitrogen for 10-15 minutes and then flowed through the glass column for 30-60 minutes using the peristaltic pump to equilibrate the glass column. The 300 Watt halogen light was turned on to illuminate the glass column and its contents. Illumination time was controlled by adjusting the flow rate of the glass column with the peristaltic pump connected to the inlet tubing. A flow rate of 0.35 ml/min through the column was used. Then, the potassium dichromate batch sample was injected through a 0.25 ml injection valve connected to the inlet tubing while the buffer solution was being pumped through the glass column. Samples were collected from the outlet tubing and analyzed using a spectrometer. The analyzed samples indicated that reduction of Cr⁺⁶ to Cr⁺³ was achieved in the glass column under the above treatment conditions.

A batch sample of Nitro Blue Tetrazolium (1 mM NBT aqueous solution) was pulse injected into the glass column under similar treatment conditions. The NBT was reduced to NBT-Formazan as evidenced by the dye turning blue in the glass column.

A batch sample of TCE (0.1 mM TCE aqueous solution) was pulse injected into the glass column under similar treatment conditions and reduced to daughter products.

Although the above Example refers to pulse injection of a batch sample in the inlet tubing to the glass column, the glass column can be operated in a mode wherein water containing the contaminated or unwanted species or recoverable species (e.g. contaminated groundwater or aqueous solution) is premixed with an electron donor buffer solution in a container or tank, if necessary, which mixture then is pumped continuously through the continuous flow column having the porphyrin coated glass beads packed therein to reduce reducible species that may be present in the contaminated groundwater or other aqueous solution.

While certain embodiments of the invention have been described in detail above, those skilled in the art will appreciate that changes and modifications can be made therein within the scope of the invention as set forth in the appended claims.

What is claimed is:

1. Treatment method for water that contains a reducible species, comprising contacting the water to be treated and a metal porphyrin on a substrate in a reactor to achieve reduction of the reducible species.

2. The method of claim 1 wherein the reduction of the species is catalyzed.

3. The method of claim 2 wherein the reduction is catalyzed by light activation of the metal porphyrin.

4. The method of claim 2 wherein the reduction is catalyzed by electrical activation of the metal porphyrin.

5. The method of claim 1 wherein an electron donor material is added to the water to be treated before and/or after introduction into the reactor.

6. The method of claim 5 wherein the electron donor material comprises a carbon source electron donor.

7. The method of claim 6 wherein the electron donor comprises an alcohol.

8. The method of claim 1 wherein an electron donor is provided in the reactor comprising a DC electrical voltage or current applied to the metal porphyrin.

9. The method of claim 1 including providing a monolayer of the metal porphyrin on the substrate.

10. The method of claim 9 wherein the monolayer is disposed on glass beads in a reactor column.

11. The method of claim 1 wherein the metal porphyrin comprises one of tin porphyrin or antimony porphyrin.

12. The method of claim 1 wherein the water comprises contaminated groundwater, surface water or an aqueous solution.

13. The method of claim 1 wherein the water comprises waste water from a manufacturing process.

14. The method of claim 1 wherein the reducible species comprises metal cations dissolved in the water.

15. The method of claim 14 wherein the metal cations include one or more of Au, Ag, Pt, Cu, Cr, Pb, Hg or U cations.

16. The method of claim 1 wherein the reducible species comprises metal-oxygen cations dissolved in the water.

17. The method of claim 1 wherein the reducible species comprises anions dissolved in the water.

18. The method of claim 17 wherein the anions include one or more of perchlorate, chlorate, or chlorite anions.

19. The method of claim 17 wherein the anions include nitrate anions.

20. The method of claim 1 wherein the reducible species comprises a halogenated hydrocarbon.

21. The method of claim 20 wherein the halogenated hydrocarbon comprises trichloroethylene.

22. The method of claim 1 wherein the reducible species comprises an organic dye.

23. The method of claim 22 wherein the dye comprises nitroblue tetrazolium.

24. The method of claim 1 wherein the reducible species comprises a recoverable resource species.

25. Treatment method for water that contains a reducible species, comprising contacting the water to be treated, an electron donor material, and light activated metal porphyrin on a substrate in a reactor to achieve reduction of the reducible species.

26. The method of claim 25 wherein the electron donor material is ethanol.
